(19) United States
(12) Patent Application Publication
(10) Pub. No.: US 2025/0329126 A1
(43) Pub. Date: Oct. 23, 2025

(54) METHOD AND DEVICE FOR SUPPORTING THE DETECTION OF THE SURROUNDINGS OF A VEHICLE TRAVELING IN AN AUTOMATED MANNER

(71) Applicant: VOLKSWAGEN AKTIENGESELLSCHAFT, Wolfsburg (DE)

(72) Inventors: Robin PHILIPP, Schwülper (DE); Jana REHBEIN, Braunschweig (DE); Lukas HARTJEN, Braunschweig (DE); Andreas BUSSLER, Wolfsburg (DE); Fabian SCHULDT, Meinersen (DE)

(21) Appl. No.: 18/570,877

(22) PCT Filed: Jun. 16, 2022
(86) PCT No.: PCT/EP2022/066490

§ 371 Date: Sep. 5, 2024

(30) Foreign Application Priority Data
Jul. 2, 2021 (DE) 10 2021 206 983.5

(51) Int. Cl. G06V 10/25; G06V 20/56

(52) U.S. Cl. CPC G06V 10/25; G06V 20/56

(57) ABSTRACT

An automated method and device detects of transportation vehicle surroundings by determining a manoeuvre category of a currently performed manoeuvre of the transportation vehicle, ascertaining, based on the determined manoeuvre category, at least one base region assigned to the determined maneuver category in a stored association, determining a respective associated relevant region of the surroundings in the transportation vehicle surroundings for the ascertained at least one base region taking into consideration of current parameters of the transportation vehicle and/or the surroundings, wherein the relevant regions of the surroundings determined for each of the at least one base region are provided for the detection of the surroundings such that the surroundings detection are performed in consideration of the surroundings regions determined in each case.

### PRIORITY CLAIM

This patent application is a U.S. National Phase of International Patent Application No. PCT/EP2022/066490, filed 16 Jun. 2022, which claims priority to German Patent Application No. 10 2021 206 983.5, filed 2 Jul. 2021, the disclosures of which are incorporated herein by reference in their entireties.

### SUMMARY

Illustrative embodiments relate to a method and a device for supporting the detection of the surroundings of a transportation vehicle traveling in an automated manner.

### BRIEF DESCRIPTION OF THE DRAWINGS

Disclosed embodiments will be described in more detail below with reference to drawings, in which:

FIG. 1 shows a schematic representation of an embodiment of the device for supporting the detection of the surroundings of a transportation vehicle traveling in an automated manner;

FIG. 2 shows a schematic representation to illustrate an association between maneuver categories and base regions;

FIG. 3 shows a first schematic representation to illustrate the determination of the relevant region of the surroundings from the base region;

FIG. 4 shows a second schematic representation to illustrate the determination of the relevant region of the surroundings from the base region;

FIG. 5 shows a third schematic representations to illustrate the determination of the relevant region of the surroundings from the base region;

FIG. 6 shows a fourth schematic representations to illustrate the determination of the relevant region of the surroundings from the base region;

FIG. 7 shows a fifth schematic representations to illustrate the determination of the relevant region of the surroundings from the base region;

FIG. 8 shows a sixth schematic representations to illustrate the determination of the relevant region of the surroundings from the base region;

FIG. 9 shows a schematic representation of an illustrative acceleration profile of a transportation vehicle;

FIG. 10 show schematic representations to illustrate the determination of the relevant region of the surroundings from the base region;

FIG. 11 show schematic representations to illustrate the determination of the relevant region of the surroundings from the base region;

FIG. 12 shows a schematic representation to illustrate relevant regions of the surroundings in real surroundings; and

FIG. 13 shows a schematic flowchart for an embodiment of the method for supporting the detection of the surroundings of a transportation vehicle traveling in an automated manner.

### DETAILED DESCRIPTION

The task of detection of the surroundings or perception of the surroundings (sensor system and processing) by automated driving functions is to capture, or detect, surrounding road users, such as e.g., transportation vehicles, cyclists or pedestrians. Capture of the road users relevant to a driving task is a prerequisite for safe action by the transportation vehicle traveling in an automated manner. Particularly in the urban traffic space, however, a large number of different road users are on the move that are not always all relevant to the future behavior of the transportation vehicle. As such, non-detection of a transportation vehicle traveling ahead must be categorized as far more critical than non-detection of a cyclist crossing the road at a safe distance behind the transportation vehicle. Detection of the surroundings should therefore be goal-directed.

US 2019/0374151 A1 discloses a method for the focus-based marking of sensor data. Data from sensors of a transportation vehicle are captured together with data that track the gaze of a driver. The route covered by the transportation vehicle may also be captured. The gaze of the driver is evaluated in regard to the sensor data to establish the feature on which the driver was focused. A focus dataset is created for the feature. Focus recordings for many drivers may be aggregated in order to determine a frequency with which the feature is observed. A machine learning model may be trained using the focus datasets in order to identify a region of interest for a given scenario, in order to identify relevant hazards more quickly.

US 2020/0130682 A1 discloses a safety system, an automated driving system and associated methods. In some aspects, the safety system may be configured to receive transportation vehicle position data that indicate a position of a transportation vehicle, to determine a first lane segment in a lane coordinate system on the basis of the transportation vehicle position data, the first lane segment being a lane segment in which the transportation vehicle is located, to determine a relevant set of lane segments on the basis of a safety region of the first lane segment, to determine or receive obstacle position data that indicate a second lane segment in the lane coordinate system, the second lane segment being a lane segment in which an obstacle is located, and to classify the obstacle either as a nonrelevant obstacle, if the second lane segment is not included in the relevant set of lane segments, or as a relevant obstacle, if the second lane segment is included in the applicable set of lane segments.

Disclosed embodiments provide a method and a device for supporting the detection of the surroundings of a transportation vehicle traveling in an automated manner that allow detection of the surroundings, in particular in respect of goal-directed detection of the surroundings, to be improved.

In particular, a method for supporting the detection of the surroundings of a transportation vehicle traveling in an automated manner is provided, wherein a maneuver category of a currently performed maneuver of the transportation vehicle is determined, wherein the determined maneuver category is taken as a basis for ascertaining at least one base region assigned to the determined maneuver category in a stored association, wherein a respective associated relevant region of the surroundings in the surroundings of the transportation vehicle is determined for the ascertained at least one base region in consideration of current parameters of the transportation vehicle and/or the surroundings, wherein the relevant regions of the surroundings determined for each of the at least one base region are provided for the detection of the surroundings, with the result that the detection of the surroundings may be performed in consideration of the relevant regions of the surroundings determined in each case.

Furthermore, in particular a device for supporting the detection of the surroundings of a transportation vehicle traveling in an automated manner is provided, comprising a data processing apparatus having at least one computing apparatus and at least one memory, wherein the data processing apparatus is configured to determine a maneuver category of a currently performed maneuver of the transportation vehicle, to take the determined maneuver category as a basis for ascertaining at least one base region assigned to the determined maneuver category in a stored association, to determine a respective associated relevant region of the surroundings in the surroundings of the transportation vehicle for the ascertained at least one base region in consideration of current parameters of the transportation vehicle and/or the surroundings, and to provide the relevant regions of the surroundings determined for each of the at least one base region for the detection of the surroundings, with the result that the detection of the surroundings may be performed in consideration of the relevant regions of the surroundings determined in each case

The method and the device allow regions of the surroundings in the surroundings of the transportation vehicle that are relevant to detection of the surroundings to be determined. This allows the detection of the surroundings to be focused on these relevant regions of the surroundings in a goal-directed manner, for example, in order to detect obstacles and other road users in these relevant regions of the surroundings. A basic concept here is to subdivide a behavior of the transportation vehicle into maneuvers in different maneuver categories. A maneuver category is in particular a semantic subdivision of a, in particular progressive, behavior of the transportation vehicle traveling in an automated manner. A maneuver category may here be one of the following, for example: following a lane, changing lane, approaching an intersection, crossing an intersection, turning left, turning right, approaching a pedestrian crossing or crossing a pedestrian crossing, etc. In an association stored in a memory provided for this purpose in the device, for example, each maneuver has assigned base regions that define regions relevant to this maneuver relative to the transportation vehicle or with reference to the surroundings.

By way of example, these base regions may be defined as follows:
a region that comprises transportation vehicles traveling in front and adjacent transportation vehicles,
a region that comprises approaching transportation vehicles in a lane to which there is an intention to change,
a region that comprises approaching transportation vehicles in a lane that is adjacent to a lane to which there is an intention to change,
a region that comprises transportation vehicles traveling in a lane that is merged with a lane in which the transportation vehicle is traveling,
a region that comprises transportation vehicles in intersecting lanes,
a region that comprises vulnerable road users at pedestrian crossings, etc.

The base regions are in particular defined generally here. This means in particular that the base regions (still) have no specific reference (e.g., exact dimensions, positions, etc.) to current surroundings of the transportation vehicle, but rather are defined generally (e.g., base region comprises pedestrian crossing) relative to the transportation vehicle or only in regard to a maneuver.

By way of example, the base regions may be stipulated manually for the different maneuver categories and stored in the association. However, there may also be provision for the base regions to be stipulated in an automated manner, for example using machine learning methods and/or artificial intelligence.

The determined maneuver category is taken as a basis for ascertaining at least one base region assigned to the determined maneuver category in the stored association. A maneuver category may have a single or multiple assigned base region(s) in the association.

Since the base regions are defined only generally, a respective associated relevant region of the surroundings in the surroundings of the transportation vehicle is determined for the ascertained at least one base region in consideration of current parameters of the transportation vehicle and/or the surroundings. To put it another way, the generally defined base regions are in particular converted into relevant regions of the surroundings determined specifically for the current surroundings.

Current parameters of the transportation vehicle in this case are in particular a position, a speed and/or an acceleration, etc. Current parameters of the surroundings are in particular lane paths and lanes, which may be determined, for example, on the basis of a roadmap, and also a position and/or a layout of pedestrian crossings, etc. Another current parameter relating to the surroundings may be a permissible maximum speed in lanes in the surroundings, which may likewise be retrieved from a map or determined from captured sensor data (e.g., by evaluating road signs in the surroundings). Parameters relating to the transportation vehicle and the surroundings may likewise comprise braking and/or acceleration values and/or reaction times for the transportation vehicle and/or other vehicles. In particular, such braking and/or acceleration values and/or reaction times may comprise typical values or statistical average values.

The relevant regions of the surroundings may be determined in particular on the basis of parameterizable equations predefined for each of the individual base regions. For the purposes of determination, an equation is then parameterized using the current parameters and this is used to determine the specific relevant region of the surroundings. There is in particular provision in this instance for the respective worst case in a given traffic situation to be taken into account (worst-case scenario), which means that there is in particular a safety tolerance.

The relevant regions of the surroundings determined for each of the at least one base region are provided for the detection of the surroundings, which means that the detection of the surroundings may be performed in consideration of the regions of the surroundings determined in each case. By way of example, the determined relevant region(s) of the surroundings may be taken into account for the detection of the surroundings in order to allocate computing power for processing surroundings data, which means that a focus for processing and/or evaluating the surroundings data may be placed on the determined relevant region(s) of the surroundings. This allows limited computing and/or memory resources to be used in a goal-directed manner.

An advantage of the method and the device is that determining the relevant regions of the surroundings facilitates goal-directed detection of the surroundings. The relevant regions of the surroundings are already predefined generally in the association and linked to the maneuver categories, which means that only the specific refinements need to be made on the basis of the current situation (transportation vehicle and surroundings). This approach simplifies complexity and permits a computing power and a memory requirement to be saved or kept low as early as for determining the relevant regions of the surroundings.

Parts of the device may be individually or collectively in the form of a combination of hardware and software, for example, in the form of program code executed on a microcontroller or microprocessor. However, there may also be provision for parts to be individually or collectively in the form of an application-specific integrated circuit (ASIC) and/or field-programmable gate array (FPGA). The data processing apparatus in this case comprises in at least one of computing apparatuses and at least one memory.

In one exemplary embodiment, there is provision for the detection of the surroundings to be configured such that the detection of the surroundings is limited to the relevant regions of the surroundings. This allows available resources (sensor system, computing power, memory, etc.) of the transportation vehicle to be used in a goal-directed manner (and possibly in full) for the detection of the surroundings in the relevant regions of the surroundings

In one exemplary embodiment, there is provision for the steps to be performed during the operation of the transportation vehicle. The relevant regions of the surroundings are determined during the automated driving of the transportation vehicle in this instance. To put it another way, the steps for determining the relevant regions of the surroundings are performed in online mode.

In one exemplary embodiment, there is provision for the steps to be performed on the basis of stored surroundings data and/or transportation vehicle data, wherein the determined relevant regions of the surroundings are stored at corresponding positions in a map of the surroundings, the map of the surroundings being provided for the detection of the surroundings. This also allows the method to be used for preparing and/or planning a subsequently performed capture of the surroundings. In particular, it allows a computing requirement and/or memory requirement necessary for the detection of the surroundings to be reduced, since the relevant regions of the surroundings may be retrieved from the provided map when the transportation vehicle is traveling in an automated manner.

In one exemplary embodiment, there is provision for a respective change state of sets of traffic lights arranged in the surroundings to be taken into account for determining the relevant regions of the surroundings. This allows the relevant regions of the surroundings to be restricted further, thereby allowing a need for computing power and/or memory to be reduced further. In particular, there may be provision for relevant regions of the surroundings or subregions of relevant regions of the surroundings that correspond to regions in which traffic streams are brought to a halt by an applicable change state of a set of traffic lights (e.g., traffic lights are on “red”) not to be intended for the detection of the surroundings, or for a relevant region of the surroundings to be reduced as appropriate around the subregions that are affected by an applicable change state of the set of traffic lights. To put it another way, traffic streams that are blocked by a change state of a set of traffic lights are ignored for the detection of the surroundings or are taken into account with lower complexity.

In one exemplary embodiment, there is provision for a computing-resource-dependent reaction time of the transportation vehicle to be taken into account for determining at least one of the respective associated relevant regions of the surroundings. This allows a relevant region of the surroundings to be determined on the basis of a current performance capability of the surroundings detection and/or of the transportation vehicle traveling in an automated manner. If detection of the surroundings needs to process many relevant regions of the surroundings, for example, and/or if many obstacles and/or other road users can be detected and/or tracked in these relevant regions of the surroundings, a computing time required for this may increase. This leads to the reaction time of the transportation vehicle when traveling in an automated manner becoming greater. To allow for this, the relevant regions of the surroundings are determined in consideration of the reaction time. By way of example, a relevant region of the surroundings may be enlarged if a reaction time increases so that in particular even transportation vehicles traveling at a greater distance that, owing to the longer reaction time, could potentially collide with the transportation vehicle may be taken into account for the detection of the surroundings. The reaction time of the transportation vehicle in this case is usually in the region of a few hundred milliseconds, this being dependent on a total available or usable computing power in the transportation vehicle and/or on a total available or usable memory space.

In one exemplary embodiment, there is provision for an acceleration profile of the transportation vehicle stipulated on the basis of the determined maneuver category to be taken into account for determining at least one of the respective associated relevant regions of the surroundings. This allows a behavior of the transportation vehicle when executing the current maneuver to be taken into account in an improved manner for determining the relevant regions of the surroundings. The acceleration profile may comprise both an acceleration, a slowing (deceleration) and a constant speed (acceleration equal to zero).

In one exemplary embodiment, there is provision for the respective associated relevant region of the surroundings to be determined in consideration of the directive for the design of urban roads (RASt). In particular, details from the directive regarding visibilities in intersection regions may be taken into account. This generally allows a relevant region of the surroundings to be reduced, since visibility is limited anyway. This allows computing power and/or memory space to be saved.

Further features to refine the device will be obtained from the description of variants of the method. The advantages of the device are here in each case the same as for the variants of the method.

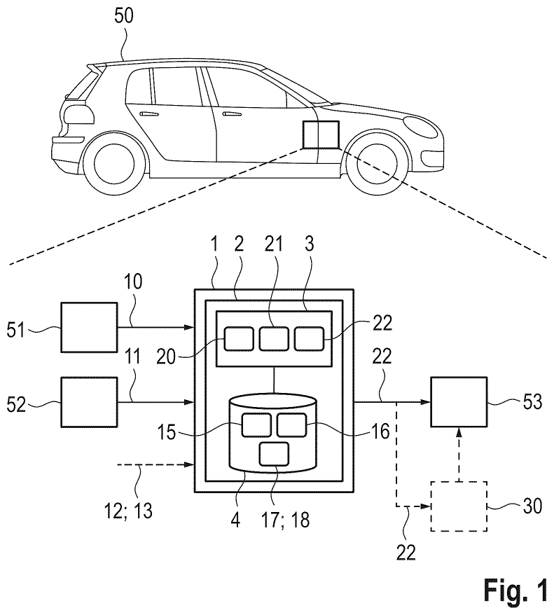

FIG. 1 shows a schematic representation of an exemplary embodiment of the device 1 for supporting the detection 53 of the surroundings of a transportation vehicle 50 traveling in an automated manner. By way of example, the device 1 is arranged in the transportation vehicle 50 and is used in particular to prepare for the detection 53 of the surroundings.

The device 1 comprises a data processing apparatus 2 having a computing apparatus 3 and a memory 4.

The data processing apparatus 2 is configured to determine a maneuver category 20 of a currently performed maneuver of the transportation vehicle 50. To this end, the data processing apparatus 2 is supplied with, by way of example, state data relating to the transportation vehicle 50, such as e.g., sensor data 10 captured by a sensor system 51 of the transportation vehicle 50, and navigation data 11 (e.g., a planned journey route, maximum speeds, path of the lanes, etc.) provided by a navigation apparatus 52 of the transportation vehicle 50. The sensor data 10 and the navigation data 11 may comprise both transportation vehicle data and surroundings data. The data processing apparatus 2 evaluates the state data and uses methods known per se to determine the maneuver category 20 of the currently performed maneuver therefrom.

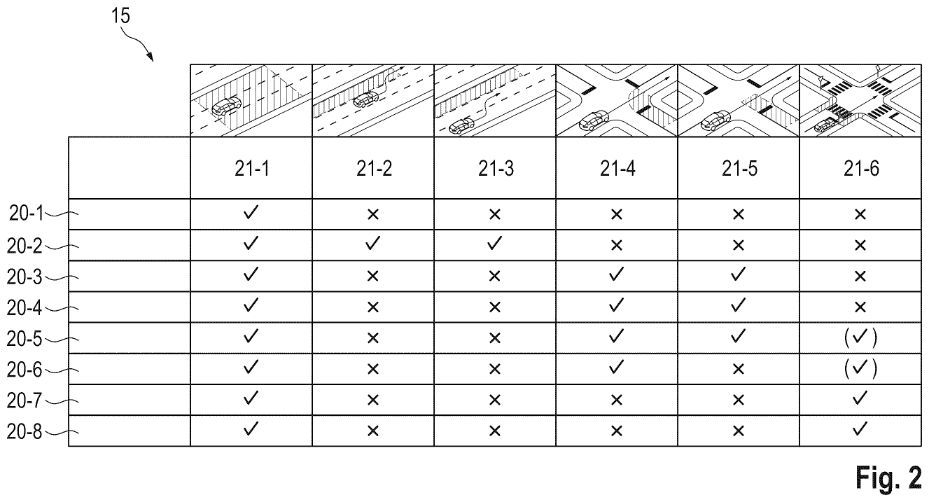

On the basis of the determined maneuver category 20, the data processing apparatus 2 ascertains at least one base region 21 assigned to the determined maneuver category 20 in a stored association 15. The association 15 (cf. FIG. 2) may comprise a tabular association, for example, in which respectively assigned base regions 21 are stored for each maneuver category 20.

The data processing apparatus 2 determines a respective associated relevant region 22 of the surroundings in the surroundings of the transportation vehicle 50 for the ascertained at least one base region 21 in consideration of current parameters of the transportation vehicle 50 and/or the surroundings. The parameters are here determined on the basis of the state data relating to the transportation vehicle 50 and on the basis of surroundings data relating to the surroundings, in particular on the basis of the sensor data 10 and the navigation data 11.

The relevant regions 22 of the surroundings determined for each of the at least one base region 21 are provided by the data processing apparatus 2 for the detection 53 of the surroundings, with the result that the detection 53 of the surroundings may be performed in consideration of the regions 22 of the surroundings determined each case. The relevant regions 22 of the surroundings are provided in the form of a data packet, for example.

There may in particular be provision for the detection 53 of the surroundings to be configured such that the detection 53 of the surroundings is limited to the relevant regions 22 of the surroundings.

There may alternatively also be provision for the steps to be performed on the basis of stored surroundings data 12 and/or transportation vehicle data 13, wherein the determined relevant regions 22 of the surroundings are stored at corresponding positions in a map 30 of the surroundings, the map 30 of the surroundings being provided for the detection 53 of the surroundings. In this alternative, the device 1 may in particular be arranged outside the transportation vehicle 50. By way of example, the device 1 may be in the form of a central server, the map 30 of the surroundings being transmitted to the transportation vehicle 50 after the steps have been performed, and the relevant regions 22 of the surroundings stored in the transportation vehicle being retrieved there from the map 30 of the surroundings for the detection 53 of the surroundings.

There may be provision for a respective change state of sets of traffic lights arranged in the surroundings to be taken into account for determining the relevant regions 22 of the surroundings. The change state (e.g., “red”, “green”, etc.) may be determined on the basis of the captured sensor data 10, for example. Alternatively or additionally, the change state may also be requested and/or received via a car-to-infrastructure interface and/or a car-to-car interface. Relevant regions 22 of the surroundings, which comprise traffic streams and/or roadway sections blocked by the change state of a set of traffic lights, for example, may then be reduced or rejected.

There may be provision for a computing-resource-dependent reaction time of the transportation vehicle 50 to be taken into account for determining at least one of the respective associated relevant regions 22 of the surroundings.

There may be provision for an acceleration profile 16 of the transportation vehicle 50 stipulated on the basis of the determined maneuver category 20 to be taken into account for determining at least one of the respective associated relevant regions 22 of the surroundings.

There may furthermore be provision for the respective associated relevant region 22 of the surroundings to be determined in consideration of a directive 17 for the design of urban roads (RASt). In particular, visibilities 18 may be taken into account.

FIG. 2 shows a schematic representation to illustrate an association 15 between maneuver categories 20-x and base regions 21-x. In the example shown, the association 15 is in the form of a table in which the individual maneuver categories 20-x are linked to the individual base regions 21-x. The maneuver categories 20-x and the base regions 21-x may have been determined and/or defined manually or in an automated manner on the basis of empirical data, for example. For a determined maneuver category 20-x, the base regions 21-x assigned to this maneuver category 20-x are ascertained on the basis of the association 15. If the determined maneuver category 20-x is 20-6, for example, then the base regions 21-1 and 21-4 and, if a pedestrian crossing is present at the intersection ahead, also the base region 21-6 are ascertained as being associated therewith.

In this instance, the base regions 21-x correspond in particular to the following regions:
a base region 21-1 that comprises transportation vehicles traveling in front and adjacent transportation vehicles,
a base region 21-2 that comprises approaching transportation vehicles in a lane to which there is an intention to change,
a base region 21-3 that comprises approaching transportation vehicles in a lane that is adjacent to a lane to which there is an intention to change,
a base region 21-4 that comprises transportation vehicles traveling in a lane that is merged with a lane in which the transportation vehicle is traveling,
a base region 21-5 that comprises transportation vehicles in intersecting lanes,
a base region 21-6 that comprises vulnerable road users at pedestrian crossings.

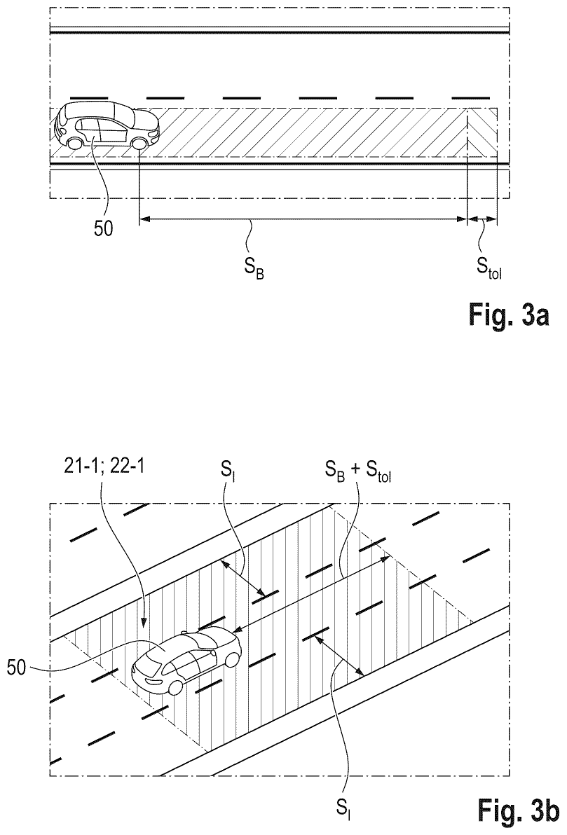

FIGS. 3 to 11 are used to explain the determination of the relevant regions 22-x of the surroundings on the basis of the base regions 21-x by way of illustration below. In the examples shown, the determination is effected on the basis of parameterizable equations by inserting the respective parameters (of the transportation vehicle and/or the surroundings) into the equations as appropriate.

FIGS. 3a and 3b show schematic representations to illustrate the determination of the relevant region 22-1 of the surroundings from the base region 21-1. The determination is accomplished here using an equation by way of a lane width Sₗ known from a map of the surroundings and an additional tolerance distance Sₜₒₗ.

In this case, a distance S_{B} to be monitored in front of the transportation vehicle 50 is obtained using:

$${S}_{B} = \frac{{a}_{acell , max} \cdot {t}_{reaction}^{2}}{2} + {v}_{0} \cdot {t}_{reaction} + \frac{{( {a}_{acell , max} \cdot {t}_{reaction} + {v}_{0} )}^{2}}{2 \cdot {a}_{brake , max}}$$

The first summand relates to a distance covered during the reaction time t_{reaction} on the basis of a maximum possible acceleration a_{acell,max}, the second summand relates to a distance covered in the reaction time t_{reaction} on the basis of a constant speed v₀ and the third summand relates to a braking distance for the reaction time t_{reaction} given maximum braking (deceleration) at a_{brake,max}.

The relevant region is then obtained as shown in FIG. 3b from a sum comprising a transportation vehicle length and S_{B}+Sₗ and the two adjacent lanes with the lane width Sₗ and a width Sₗ of the lane of the transportation vehicle.

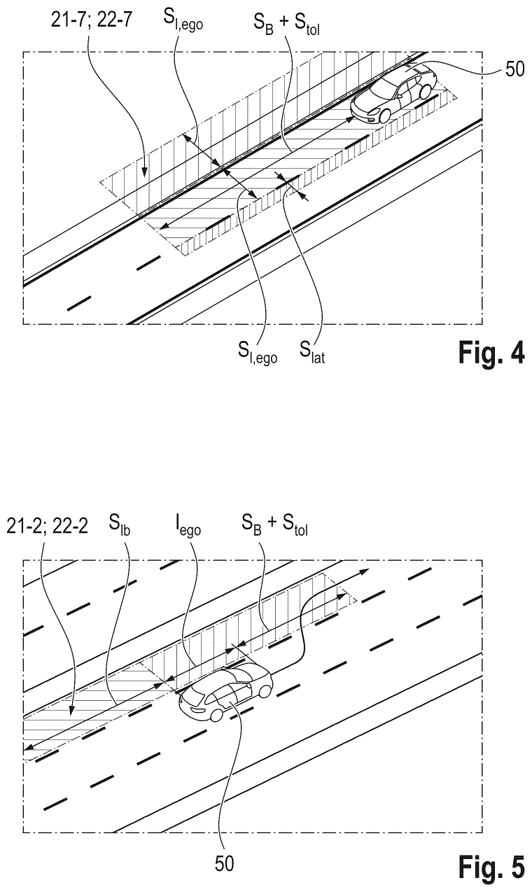

If oncoming traffic comprising oncoming transportation vehicles can be expected (FIG. 4), then the relevant region 22-7 of the surroundings may be computed as follows from an applicable base region 21-7, for example, using the above equation for S_{B} with the tolerance Sₜₒₗ, additionally in consideration of a lateral offset Sₗₐₜ, in order in particular to take account of the transportation vehicle pulling out onto a laterally adjacent region in a respective oncoming roadway:

$${S}_{lat} = {S}_{lat , ego} + {S}_{lat , obj} + {S}_{tol}$$

$$with$$

$${S}_{lat , ego} = \frac{{a}_{ego , lat accel , max} \cdot {t}_{reaction , ego}^{2}}{2} + \frac{{( {a}_{ego , lat accel , max} \cdot {t}_{reaction , ego} )}^{2}}{2 \cdot {a}_{ego , lat brake , max}}$$

$${S}_{lat , obj} = \frac{{a}_{obj , lat accel , max} \cdot {t}_{reaction , obj}^{2}}{2} + \frac{{( {a}_{obj , lat accel , max} \cdot {t}_{reaction , obj} )}^{2}}{2 \cdot {a}_{obj , lat brake , max}}$$

The first summands in this case relate to a distance as a result of maximum lateral acceleration α_{ego,lat accel,max}, or a_{obj,lat accel,max}, for a reaction time t_{reaction,ego} of the transportation vehicle 50 (“ego”) or a reaction time t_{reaction,obj} of an oncoming transportation vehicle (“obj”), respectively. The second summands relate to a lateral acceleration when braking at a_{ego,lat brake,max} or at a_{obj,lat brake,max} for the reaction times t_{reaction,ego} and t_{reaction,obj}, respectively. This results in a relevant region 22-7 of the surroundings as shown in FIG. 4 in consideration of the variable S_{l,ego} for the lane width of the transportation vehicle 50, which corresponds to the width of the transportation vehicle 50.

FIG. 5 shows a schematic representation to illustrate the determination of the relevant region 22-2 of the surroundings from the base region 21-2, which comprises approaching transportation vehicles in a lane to which there is an intention to change. Besides the initially indicated equation for computing S_{B} and a length of the transportation vehicle 50 l_{ego}, it is also possible to use the following equation to determine the rear subregion having a distance S_{lb}:

$${S}_{lb} = \frac{{v}_{limit}^{2}}{2 {a}_{brake , max}} + {t}_{reaction} \cdot {v}_{limit}$$

where vₗᵢₘᵢₜ denotes a current speed limit. The relevant region 22-2 of the surroundings may then be determined according to variables shown in FIG. 5 and a lane width Sₗ of the adjacent lane.

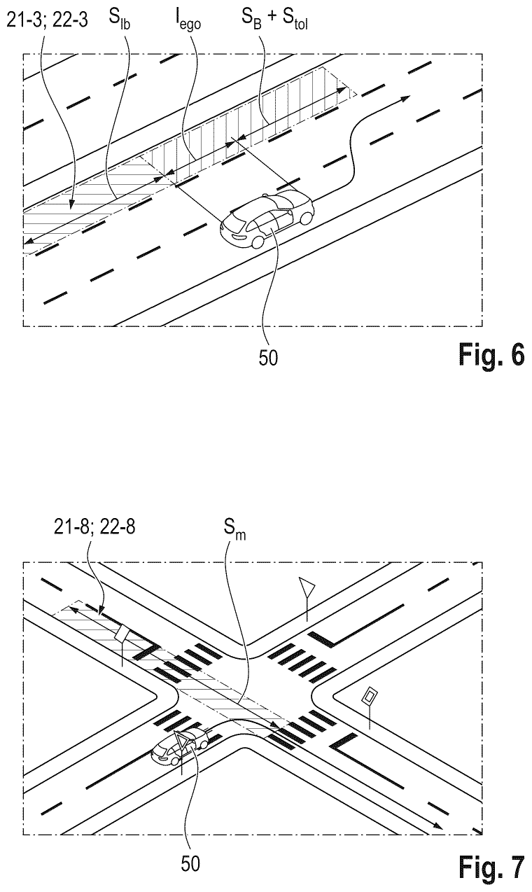

FIG. 6 shows a schematic representation to illustrate the determination of the relevant region 22-3 of the surroundings from the base region 21-3, which comprises approaching transportation vehicles in a lane that is adjacent to a lane to which there is an intention to change. The determination is accomplished here in principle as for the base region 21-2 shown in FIG. 5 or the relevant region 22-2 of the surroundings that is determined therefrom.

FIG. 7 shows a schematic representation to illustrate the determination of the relevant region 22-8 of the surroundings from the base region 21-8, which comprises transportation vehicles traveling in a lane that is merged with a lane in which the transportation vehicle 50 is traveling. In this case, it is assumed that the transportation vehicle 50 does not have right of way (“Yield”).

$${S}_{m} = {S}_{B} + {t}_{ego , intersection} \cdot {v}_{limit} + ( {S}_{acc , ego} - {S}_{acc , obj} )$$

$$with$$

$${S}_{acc , ego} = \frac{{v}_{t}^{2}}{2 {a}_{ego}}$$

$${S}_{acc , obj} = {v}_{t} \cdot t = {v}_{t} \cdot \frac{{v}_{t} - {v}_{0}}{{a}_{ego}}$$

$$and$$

$${S}_{B} = {v}_{limit} \cdot {t}_{reaction} + \frac{{v}_{limit}^{2}}{2 {a}_{brake , max}}$$

where t_{ego,intersection} is the time to reach the lane at the intersection into which there is an intention to turn and vₜ is a target speed of the transportation vehicle 50 in the lane into which the transportation vehicle is turning. Together with a lane width of the lane into which the transportation vehicle is turning, which may be retrieved from a map, for example, the relevant region 22-8 of the surroundings may be determined from the base region 21-8. The term S_{acc,ego} is the distance that the transportation vehicle 50 covers while accelerating to the target speed vₜ. The term S_{acc,obj} is the distance covered by other transportation vehicles that are potentially present while the transportation vehicle 50 is accelerating to the target speed vₜ.

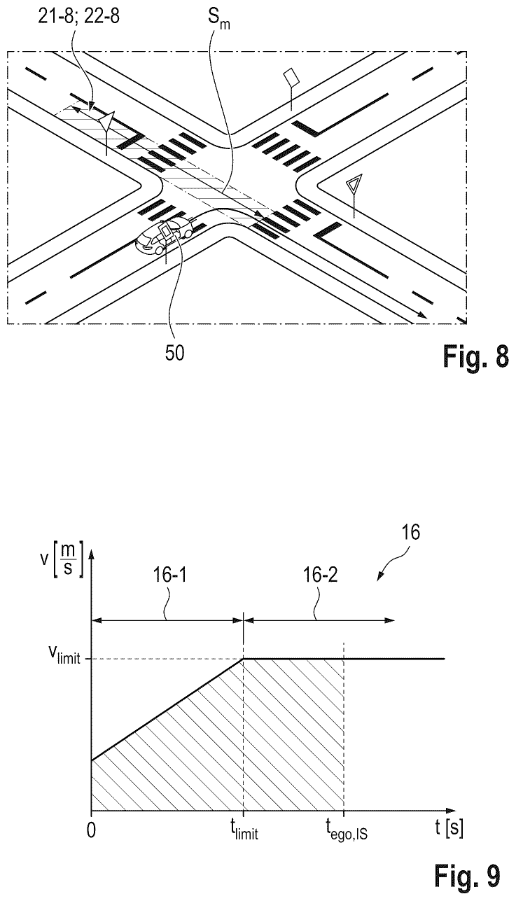

FIG. 8 shows a schematic representation to illustrate the determination of the relevant region 22-8 of the surroundings from the base region 21-8, which comprises transportation vehicles traveling in a lane that is merged with a lane in which the transportation vehicle 50 is traveling. In this case, it is assumed that the transportation vehicle 50 has right of way.

The determination may then be accomplished using the following equation:

$${S}_{m} = {v}_{limit} \cdot {t}_{reaction} + \frac{{v}_{limit}^{2}}{2 {a}_{brake , max}}$$

Compared with the situation shown in FIG. 7, Sₘ is shortened in the situation shown in FIG. 8.

There may be provision for an acceleration profile 40 of the transportation vehicle 50 stipulated on the basis of the determined maneuver category to be taken into account for determining at least one of the respective associated relevant regions 22-x of the surroundings.

Such an acceleration profile 16 is shown by way of illustration in FIG. 9 for the situation shown in FIGS. 7 and 8. The figure shows a characteristic for a speed v of the transportation vehicle over time t. In a first range 16-1, the transportation vehicle is accelerating. In a subsequent range 16-2 from a time tₗᵢₘᵢₜ onward, the limit speed vₗᵢₘᵢₜ is reached and the speed remains constant. At the speed vₗᵢₘᵢₜ, the transportation vehicle is traveling in the direction of the intersection (cf. FIGS. 7 and 8). t_{ego,IS} denotes in particular the time needed by the transportation vehicle to reach the end of the intersection, or the position at which the two lanes are combined.

On the basis of this, the following equation for determining the relevant region 22-8 of the surroundings is then obtained for the situation shown in FIG. 7:

$${S}_{m} = {t}_{ego , IS} \cdot {v}_{limit} + \frac{{v}_{limit}^{2}}{2 {a}_{obj , brake , max}} + {ρ}_{obj} \cdot {v}_{limit}$$

The first summand in this case relates in particular to a distance covered by another transportation vehicle in the time t_{ego,IS}, where t_{ego,IS} is in particular the time needed by the transportation vehicle 50 to reach the lane. vₗᵢₘᵢₜ is the maximum permissible speed (speed limit). The second and third summands relate to a braking distance of a potential other road user in the lane into which the transportation vehicle is turning. ρ_{obj} denotes a reaction time of the other road user.

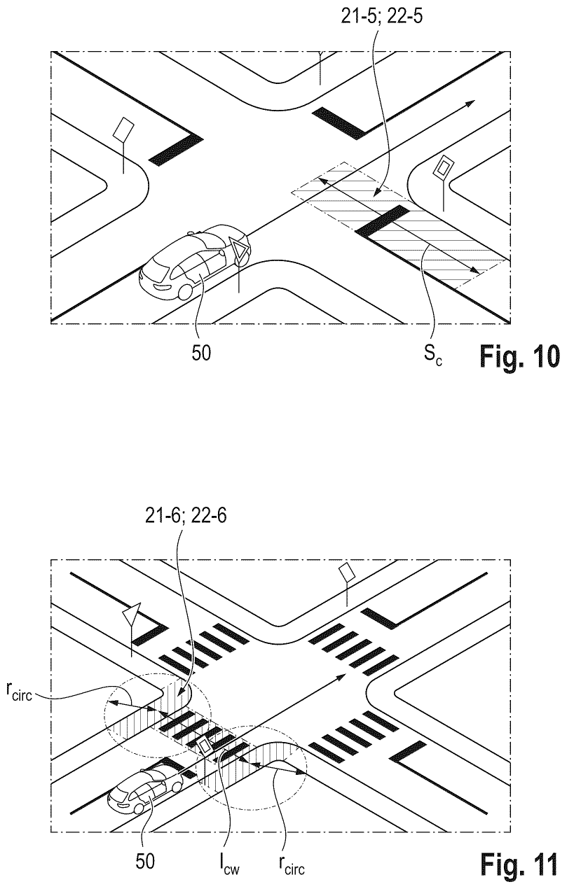

FIG. 10 shows a schematic representation to illustrate the determination of the relevant region 22-5 of the surroundings from the base region 21-5, which comprises transportation vehicles in intersecting lanes. Without considering an acceleration profile 16 (FIG. 9), the relevant region 22-5 of the surroundings may be determined using the following equation:

$${S}_{c} = ( {t}_{ego , exit} - {t}_{0} ) \cdot {v}_{limit} + {s}_{tol}$$

with t_{ego,exit} as the time at which the transportation vehicle 50 has crossed the intersection, and t₀ a current time. Sₜₒₗ is in particular an additional safety distance chosen by way of illustration, which may also be omitted, however.

If the acceleration profile 16 shown in FIG. 9 is taken into account, the relevant region 22-5 of the surroundings may be determined using the following equation:

$${S}_{c} = {t}_{ego , IS} \cdot {v}_{limit} + {S}_{sm}$$

Here, Sₛₘ is in particular an additional safety distance (e.g., 20 cm) chosen by way of illustration, which may also be omitted, however.

FIG. 11 shows a schematic representation to illustrate the determination of the relevant region 22-6 of the surroundings from the base region 21-6, which comprises vulnerable road users at pedestrian crossings. In this case, the relevant region 22-6 of the surroundings may be determined on the basis of a length l_{cw} and a width (not shown) of the pedestrian crossing and of a respective circular region around the two ends of the pedestrian crossing. The circular regions may be determined using the following equation, for example:

$${r}_{circ} = {t}_{ego , cross} \cdot {v}_{max , pd}$$

where r_{circ} is the radius of the circular regions, t_{ego,cross} is the time needed by the transportation vehicle 50 to cross the pedestrian crossing and v_{max,pd} is a maximum speed of a pedestrian. The circular regions at the ends may also be trimmed around regions that are not accessible and/or that are part of regions outside the pedestrian crossing that can be used by transportation vehicles.

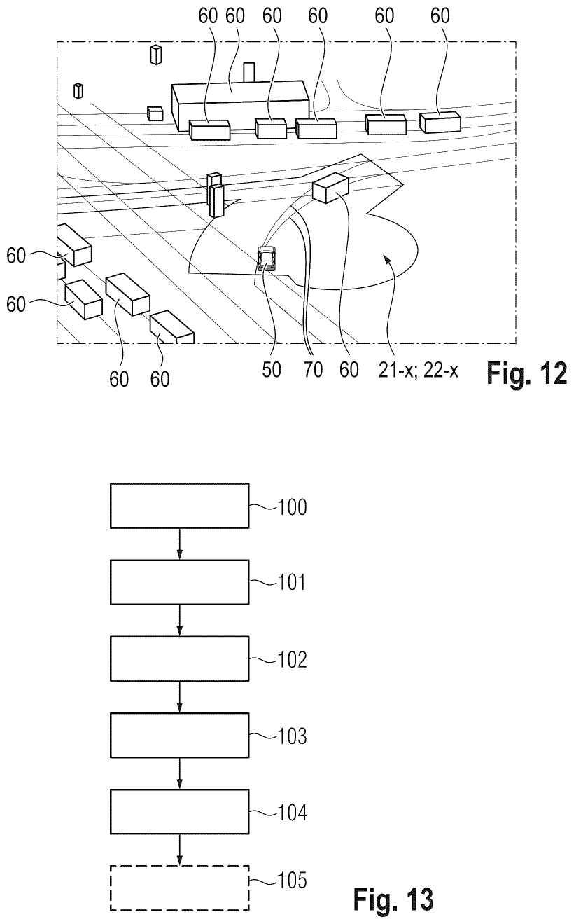

FIG. 12 shows a schematic representation to illustrate relevant regions 22-x of the surroundings in real surroundings in which the transportation vehicle 50 is moving and in which other road users 60 are present. Furthermore, schematic paths of lanes 70 are shown (only a few are provided with a separate reference sign by way of illustration), which are stored in a map and are retrieved from a map for the current surroundings on the basis of position.

FIG. 13 shows a schematic flowchart for an exemplary embodiment of the method for supporting the detection of the surroundings of a transportation vehicle traveling in an automated manner.

In a step 100, surroundings data and transportation vehicle data are received. By way of example, the surroundings data comprise map data from a map of the surroundings relating to a current position of the transportation vehicle, such as e.g., lane positions, lane widths, intersecting roadways, etc. By way of example, the transportation vehicle data comprise a current position, a speed and an acceleration of the transportation vehicle. Transportation vehicle data may furthermore also comprise a planned journey route, which may be provided by a navigation apparatus of the transportation vehicle traveling in an automated manner, for example.

In step 101, the received surroundings data and the received transportation vehicle data are taken as a basis for determining a maneuver category of a currently performed maneuver of the transportation vehicle. There are here in particular a multiplicity of predefined maneuver categories into which maneuvers may be categorized (e.g., turning left, turning right, changing lane, etc.). The maneuver category may be determined using methods known per se, for example, using artificial intelligence.

In step 102, the determined maneuver category is taken as a basis for ascertaining at least one base region assigned to the determined maneuver category in a stored association. Multiple base regions may here also be ascertained for one maneuver category.

In step 103, a respective associated relevant region of the surroundings in the surroundings of the transportation vehicle is determined for the ascertained at least one base region in consideration of current parameters of the transportation vehicle and/or the surroundings. This is accomplished in particular by parameterizing equations using parameters that are provided by way of the received surroundings data and/or transportation vehicle data. The equations define in particular dimensions or proportions of the relevant regions of the surroundings in the specific surroundings in consideration of the specific situation (speed, acceleration, reaction time, etc.).

In step 104, the relevant regions of the surroundings determined for each of the at least one base region are provided for the detection of the surroundings, with the result that the detection of the surroundings may be performed in consideration of the regions of the surroundings determined in each case.

In a step 105, there may be provision for the detection of the surroundings to be configured such that the detection of the surroundings is limited to the relevant regions of the surroundings.

There may be provision for steps 100-105 to be performed during the operation of the transportation vehicle.

There may alternatively be provision for steps 100-104 to be performed on the basis of stored surroundings data and/or transportation vehicle data, wherein the determined relevant regions of the surroundings are stored at corresponding positions in a map of the surroundings, the map of the surroundings being provided for the detection of the surroundings. Step 105 may then be performed using the map of the surroundings.

There may be provision for step 103 to involve a respective change state of sets of traffic lights arranged in the surroundings being taken into account for determining the relevant regions of the surroundings. The current change state may be determined from captured sensor data and/or requested from a traffic infrastructure, for example.

There may be provision for step 103 to involve a computing-resource-dependent reaction time of the transportation vehicle being taken into account for determining at least one of the respective associated relevant regions of the surroundings.

There may be provision for step 103 to involve an acceleration profile of the transportation vehicle stipulated on the basis of the determined maneuver category being taken into account for determining at least one of the respective associated relevant regions of the surroundings.

There may be provision for step 103 to involve the respective associated relevant region of the surroundings being determined in consideration of the directive for the design of urban roads (RASt).

### LIST OF REFERENCE SIGNS

1 device
2 data processing apparatus
3 computing apparatus
4 memory
10 sensor data
11 navigation data
12 surroundings data
13 transportation vehicle data
15 association
16 acceleration profile
16-1 first range (acceleration profile)
16-2 second range (acceleration profile)
17 directive
18 visibility
20, 20-x maneuver category
21, 21-x base region
22, 22-x relevant region of the surroundings
30 map of the surroundings
50 transportation vehicle
51 sensor system
52 navigation apparatus
53 detection of the surroundings
60 other road users
70 lane
100-105 operations of the method
l_{cw} length of pedestrian crossing
l_{ego} length of transportation vehicle
S_{B} distance
S_{c} distance (pedestrian crossing)
Sₗ lane width
Sₗₐₜ lateral offset
S_{lb} distance (rear subregion)
Sₘ distance (merged lanes)
Sₜₒₗ tolerance distance

1. A method for supporting detection of surroundings of a transportation vehicle traveling in an automated manner, the method comprising:
determining a maneuver category of a currently performed maneuver of the transportation vehicle;
ascertaining, based on the determined maneuver category, at least one base region assigned to the determined maneuver category in a stored association;
determining a respective associated relevant region of the surroundings in the surroundings of the transportation vehicle for the ascertained at least one base region based on the current parameters of the transportation vehicle and/or the surroundings; and
providing relevant regions of the surroundings determined for each of the at least one base region for the detection of the transportation vehicle surroundings such that the detection of the surroundings may be performed based on the relevant regions of the surroundings determined in each case.

2. The method claim 1, wherein the detection of the surroundings is specific and limited to the determined relevant regions of the surroundings.

3. The method of claim 1, wherein the method operations are performed during automated operation of the transportation vehicle.

4. The method of claim 1, wherein the operations are performed based on stored surroundings data and/or transportation vehicle data, wherein the method further comprises storing determined relevant regions of the surroundings in association with corresponding positions in a map of the surroundings, the map of the surroundings being provided for the detection of the surroundings during navigation of the transportation vehicle.

5. The method of claim 1, n wherein a respective change state of sets of traffic lights arranged in the surroundings is taken into account when determining the relevant regions of the surroundings.

6. The method of claim 1, wherein a computing-resource-dependent reaction time of the transportation vehicle is taken into account when determining at least one of the respective associated relevant regions of the surroundings.

7. The method of claim 1, wherein an acceleration profile of the transportation vehicle stipulated based on the determined maneuver category is taken into account when determining at least one of the respective associated relevant regions of the surroundings.

8. The method of claim 1, wherein the respective associated relevant region of the surroundings is determined based on a directive for design of urban roads.

9. A device for supporting the detection of the surroundings of a transportation vehicle traveling in an automated manner, the device comprising:
a data processing apparatus including at least one computer and at least one memory, wherein the data processing apparatus is configured to determine a maneuver category of a currently performed maneuver of the transportation vehicle to take the determined maneuver category as a basis for ascertaining at least one base region assigned to the determined maneuver category in a stored association, to determine a respective associated relevant region of the surroundings in the surroundings of the transportation vehicle for the ascertained at least one base region based on current parameters of the transportation vehicle and/or the surroundings, and to provide the relevant regions of the surroundings determined for each of the at least one base region for the detection of the surroundings such that the detection of the surroundings are performed based on the relevant regions of the surroundings determined in each case.

10. A transportation vehicle, comprising at least one device as claimed in claim 9.

11. The device of claim 9, wherein the detection of the surroundings is specific and limited to the determined relevant regions of the surroundings.

12. The device of claim 9, wherein the device operations are performed during automated operation of the transportation vehicle.

13. The device of claim 9, wherein the operations are performed based on stored surroundings data and/or transportation vehicle data, wherein the device further comprises storing determined relevant regions of the surroundings in association with corresponding positions in a map of the surroundings, the map of the surroundings being provided for the detection of the surroundings during navigation of the transportation vehicle.

14. The device of claim 9, wherein a respective change state of sets of traffic lights arranged in the surroundings is taken into account when determining the relevant regions of the surroundings.

15. The device of claim 9, wherein a computing-resource-dependent reaction time of the transportation vehicle is taken into account when determining at least one of the respective associated relevant regions of the surroundings.

16. The device of claim 9, wherein an acceleration profile of the transportation vehicle stipulated based on the determined manoeuvre category is taken into account when determining at least one of the respective associated relevant regions of the surroundings.

17. The device of claim 9, wherein the respective associated relevant region of the surroundings is determined based on a directive for design of urban roads.
